(19) United States
(12) Patent Application Publication
(10) Pub. No.: US 2017/0121537 A1
(43) Pub. Date: May 4, 2017

(54) POLYMER DISPERSIONS CONTAINING ACYLMORPHOLINES

(71) Applicant: BASF SE, Ludwigshafen (DE)

(72) Inventors: Juergen MOHR, Gruenstadt (DE); Ulrich KARL, Gruenstadt (DE); Helfried SCHEIDL, Friedelsheim (DE); Manfred DARGATZ, Worms (DE); Karl HAEBERLE, Speyer (DE); Thorsten PAUEN, Ludwigshafen (DE); Juan SALGADO VALLE, Hositalet de Llobregat (ES)

(73) Assignee: BASF SE, Ludwigshafen (DE)

(21) Appl. No.: 15/317,614

(22) PCT Filed: Jun. 3, 2015
(86) PCT No.: PCT/EP2015/062421

§ 371 Date: Dec. 9, 2016

(30) Foreign Application Priority Data
Jun. 10, 2014 (EP) 14171793.4

(51) Int. Cl. C09D 7/00; C14C 11/00; C08G 18/34; C08G 18/76; C09D 175/04; C08G 18/48

(52) U.S. Cl. CPC C09D 7/001; C09D 175/04; C08G 18/48; C08G 18/348; C08G 18/7621; C14C 11/006

(57) ABSTRACT

The present invention relates to N-acylmorpholines as solvents for use in processes for preparing polymer dispersions.

The present invention relates to aqueous polymer dispersions comprising at least one N-acylmorpholine as solvent.

The present invention further relates to a process for preparing aqueous polymer dispersions, especially polyurethane dispersions, using at least one N-acylmorpholine as solvent.

The present invention also relates to the use of N-acylmorpholines as solvents for preparing aqueous polymer dispersions.

Polymer dispersions are used in many areas of industry. They find broad use, for example, in the coating of surfaces.

Polyurethane dispersions are frequently prepared industrially by a process known as “prepolymer mixing”. In that process, polyurethanes are first prepared in an organic solvent, frequently N-methylpyrrolidone, and the resulting solution of the polyurethane is subsequently dispersed in water. During and/or after its dispersion in water, the molar mass of the polyurethane may then be increased further by means of a chain extension.

Depending on the boiling point of the solvent used, during a distillative removal, greater or lesser fractions of the solvent remain in the dispersion and influence the properties of the polyurethane dispersion.

Since not all solvents are toxicologically unobjectionable, the solvent used ought to be very largely nontoxic. WO 2005/090 430 A1 teaches the use of N-(cyclo)alkylpyrrolidones with (cyclo)alkyl radicals having 2 to 6 C atoms for this purpose. WO 10/142 617 describes substituted N-(cyclo)alkylpyrrolidones as suitable solvents.

However, there continues to be a need for polyurethane dispersions which are toxicologically unobjectionable and have advantageous applications properties.

It was an object of the present invention to provide polymer dispersions, more particularly polyurethane dispersions, which are toxicologically unobjectionable and display advantageous applications-related properties.

This object addressed by the invention is achieved by means of aqueous polymer dispersions, more particularly polyurethane dispersions, comprising at least one N-acylmorpholine of formula (I)

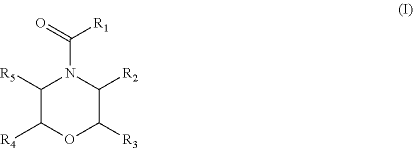

where R₁ is H or an alkyl radical having 1 to 18C atoms, and R₂, R₃, R₄, and R₅ each independently of one another are H or a (cyclo)alkyl radical having 1 to 18C atoms.

Preferred radicals R₁ are H, methyl, and ethyl, more preferably H or methyl.

Substituted N-acylmorpholines particularly suitable in accordance with the invention are those having an aliphatic (open-chain), cycloaliphatic (alicyclic, in ring form), preferably open-chain, branched or unbranched radical R₁ that comprises 0 to 5 carbon atoms, preferably 0 to 3, more preferably 0 to 2, more particularly 0 to 1 carbon atom(s).

A “(cyclo)alkyl radical having 1 to 18C atoms” in the context of the present specification means an aliphatic, open-chain, branched or unbranched hydrocarbon radical having 1 to 18 carbon atoms, or a cycloaliphatic hydrocarbon radical having 3 to 18 carbon atoms.

Examples of suitable cycloalkyl radicals are cyclopentyl, cyclohexyl, cyclooctyl, or cyclododecyl.

Examples of suitable alkyl radicals are methyl, ethyl, isopropyl, n-propyl, n-butyl, isobutyl, sec-butyl, tert-butyl, and n-hexyl.

Preferred radicals are cyclohexyl, methyl, ethyl, isopropyl, n-propyl, n-butyl, isobutyl, sec-butyl, and tert-butyl, more preferably methyl, ethyl, and n-butyl, and very preferably methyl or ethyl.

Preferred radicals R₂, R₃, R₄, and R₅ are hydrogen, methyl, ethyl, isopropyl, and cyclohexyl, more preferably hydrogen, methyl, ethyl, and isopropyl, very preferably hydrogen, methyl, and ethyl, and more particularly hydrogen and methyl.

Preferred compounds of the formula (I) are N-formylmorpholine, N-acetylmorpholine, and N-propionylmorpholine, more preferably N-formylmorpholine and N-acetylmorpholine.

In a preferred embodiment the N-acylmorpholine (I) is formylmorpholine.

In a preferred embodiment the N-acylmorpholine (I) is N-acetylmorpholine.

Where mixtures are used, they are mixtures of up to four different substituted N-acylmorpholines, preferably up to three, and more preferably two.

In the latter case, the two N-acylmorpholines are generally present in a weight ratio of 10:1 to 1:10, preferably 5:1 to 1:5, more preferably 3:1 to 1:3, and very preferably 2:1 to 1:2. In one preferred embodiment, polymer dispersions of the invention, more particularly polyurethane dispersions, comprise N-formylmorpholine and N-acetylmorpholine in a weight ratio of 10:1 to 1:10, preferably 5:1 to 1:5, more preferably 3:1 to 1:3, and very preferably 2:1 to 1:2.

The amount of the N-acylmorpholines relative to the polymer, more particularly to the polyurethane, is generally 0.01-100 wt %, preferably 1-100 wt %.

The N-acylmorpholines used in accordance with the invention may of course be employed alone, in a mixture with one another, or else mixed with one or more other suitable solvents.

Examples of suitable solvents are, for example, open-chain or preferably cyclic carbonates, lactones, di(cyclo)alkyl dipropylene glycol ethers, and N-(cyclo)alkylcaprolactams.

Carbonates are described in, for example, EP 697424 A1, particularly from page 4, lines 4 to 29 therein, hereby expressly incorporated by reference. Stated with preference may be 1,2-ethylene carbonate, 1,2-propylene carbonate, and 1,3-propylene carbonate, more preferably 1,2-ethylene carbonate and 1,2-propylene carbonate.

Stated with preference as lactones may be beta-propiolactone, gamma-butyrolactone, epsilon-caprolactone, and epsilon-methylcaprolactone.

Di(cyclo)alkyl dipropylene glycol ethers are, for example, dipropylene glycol dimethyl ether, dipropylene glycol diethyl ether, dipropylene glycol di-n-propyl ether, and dipropylene glycol di-n-butyl ether, preferably dipropylene glycol dimethyl ether.

The di(cyclo)alkyl dipropylene glycol ethers and particularly dipropylene glycol dimethyl ether are generally mixtures of the positional isomers and diastereomers. The precise composition of the isomer mixtures is unimportant to the invention. Generally speaking, the principal isomer is

R—OCH₂CH(CH₃)OCH₂CH(CH₃)OR,

in which R is the (cyclo)alkyl radical.

Dipropylene glycol dimethyl ether is available commercially as an isomer mixture of this kind, and is generally designated by the CAS No. 111109-77-4. Dipropylene glycol dimethyl ether is available commercially in a high purity of usually more than 99 wt %, for example under the trade name Proglyde® DMM from The Dow Chemical Company, Midland, Mich. 48674, USA, or from Clariant GmbH, 65840 Sulzbach am Taunus, Germany.

N-(Cyclo)alkylcaprolactams are those having an aliphatic (open-chain) or cycloaliphatic (alicyclic, ring-shaped), preferably open-chain, branched or unbranched hydrocarbon radical which comprises 1 to 6 carbon atoms, preferably 1 to 5, more preferably 1 to 4, more particularly 1 to 3, and especially 1 or 2 carbon atoms.

N-(Cyclo)alkylcaprolactams which can be used are, for example, N-methylcaprolactam, N-ethylcaprolactam, N-n-propylcaprolactam, N-isopropylcaprolactam, N-n-butylcaprolactam, N-isobutylcaprolactam, N-sec-butylcaprolactam, N-tert-butylcaprolactam, N-cyclopentylcaprolactam, or N-cyclohexylcaprolactam, preferably N-methylcaprolactam or N-ethylcaprolactam.

Aqueous polymer dispersions of the invention are preferably aqueous polyurethane dispersions.

Aqueous polymer dispersions of the invention further comprise at least one polymer. In general, aqueous polymer dispersions of the invention contain 10 to 75 wt % of polymer, based on the dispersion. Suitable polymer dispersions are known per se to the skilled person.

Aqueous polymer dispersions of the invention contain generally 90 to 25 wt % of water, based on the dispersion, with the fractions of polymer, N-acylmorpholine, other adjuvants, and water adding up to 100 wt %.

Aqueous polyurethane dispersions of the invention further comprise at least one polyurethane. In general, aqueous polyurethane dispersions of the invention contain 10 to 75 wt % of polyurethane, based on the dispersion. Suitable polyurethane dispersions are known per se to the skilled person. In one preferred embodiment, polyurethane dispersions of the invention comprise polyurethanes prepared by the prepolymer mixing process, more particularly those as described in accordance with the process of the invention, described below, for preparing polyurethane dispersions.

Aqueous polyurethane dispersions of the invention contain in general 90 to 25 wt % of water, based on the dispersion.

In one embodiment the N-acylmorpholine may also be added to a completed polymer dispersion, more particularly polyurethane dispersion, in other words after the dispersing of the polymer, more particularly the polyurethane, in order, for example, to exert advantageous influence over its flow leveling behavior and drying behavior. Preference, however, is given to adding the N-acylmorpholine prior to the dispersing.

The present invention further provides a process for preparing polyurethane dispersions, where the aqueous polyurethane dispersions are prepared as follows:

I. preparing a polyurethane by reacting
a) at least one polyfunctional isocyanate having 4 to 30 C atoms,
b) diols of which
   b1) 10 to 100 mol %, based on the total amount of the diols (b), have a molecular weight of 500 to 5000, and
   b2) 0 to 90 mol %, based on the total amount of the diols (b), have a molecular weight of 60 to 500 g/mol,
c) optionally further polyfunctional compounds, different from the diols (b), having reactive groups which are alcoholic hydroxyl groups or primary or secondary amino groups, and
d) monomers different from the monomers (a), (b), and (c) and having at least one isocyanate group or at least one group reactive toward isocyanate groups, and further carrying at least one hydrophilic group or potentially hydrophilic group, thereby making the polyurethane dispersible in water,
to give a polyurethane in the presence of an N-acylmorpholine of formula (I), and

II. subsequently dispersing the polyurethane in water,

III. where, optionally, polyamines may be added after or during step II.

Suitable monomers in (a) include the polyisocyanates customarily employed in polyurethane chemistry, examples being aliphatic, aromatic, and cycloaliphatic diisocyanates and polyisocyanates, the aliphatic hydrocarbon radicals containing for example 4 to 12 carbon atoms and the cycloaliphatic or aromatic hydrocarbon radicals containing for example 6 to 15 carbon atoms, or the araliphatic hydrocarbon radicals containing for example 7 to 15 carbon atoms, having an NCO functionality of at least 1.8, preferably 1.8 to 5, and more preferably 2 to 4, and also their isocyanurates, biurets, allophanates, and uretdiones.

The diisocyanates are preferably isocyanates having 4 to 20C atoms. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, esters of lysine diisocyanate, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, the trans/trans, the cis/cis and the cis/trans isomer of 4,4′- or 2,4′-di(isocyanatocyclohexyl)methane, 1-isocyanato-3,3,5-trimethyl-5-(isocyanatomethyl)-cyclohexane (isophorone diisocyanate), 2,2-bis(4-isocyanatocyclohexyl)propane, 1,3- or 1,4-bis(isocyanatomethyl)cyclohexane or 2,4- or 2,6-diisocyanato-1-methylcyclohexane, and also aromatic diisocyanates such as 2,4- or 2,6-tolylene diisocyanate and their isomer mixtures, m- or p-xylylene diisocyanate, 2,4′- or 4,4′-diisocyanatodiphenylmethane and their isomer mixtures, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethyl-biphenyl, 3-methyldiphenylmethane 4,4′-diisocyanate, 1,4-diisocyanatobenzene, or diphenyl ether 4,4′-diisocyanate.

Mixtures of said diisocyanates may also be present.

Preferred are aliphatic and cycloaliphatic diisocyanates; particularly preferred are isophorone diisocyanate, hexamethylene diisocyanate, meta-tetramethylxylylene diisocyanate (m-TMXDI), and 1,1-methylenebis[4-isocyanato]cyclohexane (H₁₂MDI).

Suitable polyisocyanates include polyisocyanates containing isocyanurate groups, uretdione diisocyanates, polyisocyanates containing biuret groups, polyisocyanates containing urethane groups or allophanate groups, polyisocyanates comprising oxadiazinetrione groups, uretonimine-modified polyisocyanates of linear or branched C₄-C₂₀ alkylene diisocyanates, cycloaliphatic diisocyanates having 6 to 20C atoms in all, or aromatic diisocyanates having 8 to 20C atoms in all, or mixtures thereof.

The diisocyanates and polyisocyanates which can be used preferably have an isocyanate group (calculated as NCO, molecular weight=42 g/mol) content of 10 to 60 wt % based on the diisocyanate and polyisocyanate (mixture), preferably 15 to 60 wt % and very preferably 20 to 55 wt %.

Preference is given to aliphatic and cycloaliphatic diisocyanates and polyisocyanates, examples being the abovementioned aliphatic and cycloaliphatic diisocyanates, or mixtures thereof.

Preference extends to
1) Polyisocyanates containing isocyanurate groups and formed from aromatic, aliphatic and/or cycloaliphatic diisocyanates. Particular preference is given here to the corresponding aliphatic and/or cycloaliphatic isocyanato-isocyanurates and, in particular, to those based on hexamethylene diisocyanate and isophorone diisocyanate. The isocyanurates present are, in particular, trisisocyanatoalkyl or trisisocyanatocycloalkyl isocyanurates, which represent cyclic trimers of the diisocyanates, or are mixtures with their higher homologs containing more than one isocyanurate ring. The isocyanato-isocyanurates generally have an NCO content of 10 to 30 wt %, in particular 15 to 25 wt %, and an average NCO functionality of 3 to 4.5.
2) Uretdione diisocyanates having aromatically, aliphatically and/or cycloaliphatically attached isocyanate groups, preferably aliphatically and/or cycloaliphatically attached isocyanate groups, and especially those derived from hexamethylene diisocyanate or isophorone diisocyanate. Uretdione diisocyanates are cyclic dimerization products of di isocyanates.
   In the formulations the uretdione diisocyanates can be used as sole component or in a mixture with other polyisocyanates, especially those specified under 1).
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18 to 22 wt % and an average NCO functionality of 3 to 4.5.
4) Polyisocyanates containing urethane and/or allophanate groups and having aromatically, aliphatically or cycloaliphatically attached, preferably aliphatically or cycloaliphatically attached, isocyanate groups, as obtainable for example by reacting excess amounts of hexamethylene diisocyanate or of isophorone diisocyanate with polyhydric alcohols such as trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates containing urethane and/or allophanate groups generally have an NCO content of 12 to 20 wt % and an average NCO functionality of 2.5 to 3.
5) Polyisocyanates comprising oxadiazinetrione groups, preferably derived from hexamethylene diisocyanate or isophorone diisocyanate. Polyisocyanates of this kind comprising oxadiazinetrione groups can be prepared from diisocyanate and carbon dioxide.
6) Uretonimine-modified polyisocyanates.

The polyisocyanates 1) to 6) can be used in a mixture, optionally also in a mixture with diisocyanates.

Particularly significant mixtures of these isocyanates are the mixtures of the respective structural isomers of diisocyanatotoluene and diisocyanatodiphenylmethane, with particular suitability being possessed by the mixture of 20 mol % 2,4 diisocyanatotoluene and 80 mol % 2,6-diisocyanatotoluene. Also particularly advantageous are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, with the preferred mixing ratio of the aliphatic to aromatic isocyanates being 4:1 to 1:4.

As compounds (a) it is also possible to employ isocyanates which in addition to the free isocyanate groups carry further, blocked isocyanate groups, e.g., uretdione or urethane groups.

Optionally it is also possible to use as well those isocyanates which carry only one isocyanate group. In general their fraction is not more than 10 mol %, based on the overall molar amount of the monomers. The monoisocyanates normally carry other functional groups such as olefinic groups or carbonyl groups and serve for introducing, into the polyurethane, functional groups which allow it to be dispersed and/or crosslinked or to undergo further polymer-analogous reaction. Monomers suitable for this purpose include those such as isopropenyl-α,α-dimethyl-benzyl isocyanate (TMI).

Diols (b) which are ideally suitable are those diols (b1) which have a relatively high molecular weight of about 500 to 5000, preferably of about 100 to 3000 g/mol.

The diols (b1) are, in particular, polyester polyols, which are known, for example, from Ullmanns Encyklopädie der technischen Chemie, 4th edition, vol. 19, pp. 62 to 65. It is preferred to employ polyester polyols that are obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyester polyols. The polycarboxylic acids can be aliphatic, cycloaliphatic, araliphatic, aromatic or heterocyclic and can be optionally substituted, by halogen atoms, for example, and/or unsaturated. Examples are suberic, azelaic, phthalic, and isophthalic acid, phthalic, tetrahydrophthalic, hexahydrophthalic, tetrachlorophthalic, endomethylenetetrahydrophthalic, glutaric and maleic anhydride, maleic acid, fumaric acid and dimeric fatty acids. Preference is given to dicarboxylic acids of the general formula HOOC—(CH₂)_{y}—COOH, where y is a number from 1 to 20, preferably an even number from 2 to 20, examples being succinic, adipic, sebacic and dodecanedicarboxylic acids.

Examples of suitable polyhydric alcohols are ethylene glycol, 1,2-propanediol, 1,3-propanediol, 1,3-butanediol, 1,4-butenediol, 1,4-butynediol, 1,5-pentanediol, neopentyl glycol, bis(hydroxymethyl)cyclohexanes such as 1,4-bis(hydroxymethyl)cyclohexane, 2-methyl-1,3-propanediol and also diethylene glycol, triethylene glycol, tetraethylene glycol, polyethylene glycol, dipropylene glycol, polypropylene glycol, dibutylene glycol and polybutylene glycols. Preference is given to neopentyl glycol and alcohols of the general formula HO—(CH₂)ₓ—OH, where x is a number from 1 to 20, preferably an even number from 2 to 20. Examples of such alcohols are ethylene glycol, 1,4-butanediol, 1,6-hexanediol, 1,8-octanediol and 1,12-dodecanediol.

Also suitable are polycarbonate diols, as can be obtained, for example, by reaction of phosgene with an excess of the low molecular mass alcohols cited as synthesis components for the polyester polyols.

Lactone-based polyester diols are also suitable, these being homopolymers or copolymers of lactones, preferably hydroxy-terminal adducts of lactones with suitable difunctional starter molecules. Suitable lactones are preferably those derived from hydroxycarboxylic acids of the general formula HO—(CH₂)_{z}—COOH, where z is from 1 to 20, preferably an odd number from 3 to 19; examples are ε-caprolactone, β-propiolactone, γ-butyrolactone and/or methyl-ε-caprolactone, and mixtures thereof. Examples of suitable starter components are the low molecular mass dihydric alcohols cited above as synthesis components for the polyester polyols. The corresponding polymers of E-caprolactone are particularly preferred. Lower polyesterdiols or polyetherdiols can also be employed as starters for preparing the lactone polymers. Instead of the polymers of lactones it is also possible to employ the corresponding, chemically equivalent polycondensates of the hydroxycarboxylic acids which correspond to the lactones.

Further suitable monomers (b1) are polyether diols. They are obtainable in particular by polymerization of ethylene oxide, propylene oxide, butylene oxide, tetrahydrofuran, styrene oxide or epichlorohydrin with itself, in the presence, for example, of BF₃, or by addition reaction of these compounds, optionally in a mixture or in succession, onto starter components containing reactive hydrogen atoms, such as alcohols or amines, examples being water, ethylene glycol, 1,2-propanediol, 1,3-propanediol, 2,2-bis(4-hydroxydiphenyl)propane or aniline. Preferred in particular is polytetrahydrofuran having a molecular weight of 500 to 5000 g/mol, and in particular 1000 to 4500 g/mol.

The polyester diols and polyether diols can also be employed as mixtures in proportions of 0.1:1 to 1:9.

It is possible to employ as diols (b) not only the diols (b1) but also low molecular mass diols (b2) having a molecular weight of about 50 to 500, preferably of 60 to 200 g/mol.

Components employed as monomers (b2) are in particular the synthesis components of the short-chain alkanediols mentioned for the preparation of polyester polyols, with preference being given to the unbranched diols having 2 to 12C atoms and an even number of C atoms, and also to 1,5-pentanediol and neopentyl glycol.

The proportion of the diols (b1), based on the total amount of the diols (b), is preferably 10 to 100 mol %, and the proportion of the diols (b2), based on the total amount of the diols (b), is preferably 0 to 90 mol %. With particular preference the ratio of the diols (b1) to the diols (b2) is 0.2:1 to 5:1, very preferably 0.5:1 to 2:1.

The monomers (c), which are different from the diols (b), serve generally for crosslinking or chain extension. They are generally nonaromatic alcohols with a functionality of more than two, amines having 2 or more primary and/or secondary amino groups, and compounds which as well as one or more alcoholic hydroxyl groups carry one or more primary and/or secondary amino groups.

Alcohols having a functionality greater than 2, which may serve to bring about a certain degree of crosslinking or branching, are for example trimethylolbutane, trimethylolpropane, trimethylolethane, pentaerythritol, glycerol, sugar alcohols, such as sorbitol, mannitol, diglycerol, threitol, erythritol, adonitol (ribitol), arabitol (lyxitol), xylitol, dulcitol (galactitol), maltitol or isomalt, or sugars.

Also suitable are monoalcohols which in addition to the hydroxyl group carry a further isocyanate-reactive group, such as monoalcohols having one or more primary and/or secondary amino groups, monoethanolamine being one example.

Polyamines having 2 or more primary and/or secondary amino groups are used particularly in the prepolymer mixing process when the chain extension and/or crosslinking is to take place in the presence of water (step II), since amines generally react more quickly with isocyanates than do alcohols or water. This is frequently necessary when aqueous dispersions of crosslinked polyurethanes or polyurethanes of high molar weight are required. In such cases the approach taken is to prepare prepolymers containing isocyanate groups, to disperse them rapidly in water and then to subject them to chain extension or crosslinking by adding compounds having two or more isocyanate-reactive amino groups.

Amines suitable for this purpose are generally polyfunctional amines of the molar weight range from 32 to 500 g/mol, preferably from 60 to 300 g/mol, which comprise at least two primary, two secondary or at least one primary and one secondary amino group(s). Examples of such are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane or higher amines such as triethylentetramine, tetraethylenepentamine, or polymeric amines such as polyethyleneamines, hydrogenated polyacrylonitriles or at least partly hydrolyzed poly-N-vinylformamides, in each case with a molar weight of up to 2000, preferably up to 1000 g/mol.

The amines can also be used in blocked form, such as in the form of the corresponding ketimines (see, e.g., CA-1 129 128), ketazines (cf., e.g., U.S. Pat. No. 4,269,748) or amine salts (see U.S. Pat. No. 4,292,226). Oxazolidines as well, as used for example in U.S. Pat. No. 4,192,937, are blocked polyamines which can be used for preparing the polyurethanes for chain extension of the prepolymers. When blocked polyamines of this kind are used they are generally mixed with the prepolymers in the absence of water and this mixture is subsequently mixed with the dispersion water or a portion thereof, and so the corresponding polyamines are liberated by hydrolysis.

Preference is given to using mixtures of diamines and triamines, and particular preference to mixtures of isophoronediamine and diethylenetriamine.

The polyamines fraction can be up to 10, preferably up to 8 mol % and more preferably up to 5 mol %, based on the total amount of components (b) and (c).

The polyurethane prepared in step I may have in general up to 10 wt %, preferably up to 5 wt %, of unreacted NCO groups.

The molar ratio of NCO groups in the polyurethane prepared in step I to the sum total of primary and secondary amino groups in the polyamine is generally selected in step III such that it is between 3:1 and 1:3, preferably 2:1 and 1:2, more preferably 1.5:1 and 1:1.5; very preferably 1:1.

A further possibility, for chain termination, is to use minor amounts—that is, preferably, amounts of less than 10 mol %, based on components (b) and (c)—of monoalcohols. Their function is primarily to limit the molar weight of the polyurethane. Examples are methanol, ethanol, isopropanol, n-propanol, n-butanol, isobutanol, sec-butanol, tert-butanol, ethylene glycol monomethyl ether, ethylene glycol monoethyl ether, 1,3-propanediol monomethyl ether, n-hexanol, n-heptanol, n-octanol, n-decanol, n-dodecanol (lauryl alcohol) and 2-ethylhexanol.

In order to render the polyurethanes dispersible in water they are synthesized not only from components (a), (b) and (c) but also from monomers (d), which are different from components (a), (b) and (c) and carry at least one isocyanate group or at least one group that is reactive toward isocyanate groups, and, in addition, at least one hydrophilic group or a group which can be converted into hydrophilic groups. In the text below, the term “hydrophilic groups or potentially hydrophilic groups” is abbreviated to “(potentially) hydrophilic groups”. The (potentially) hydrophilic groups react with isocyanates much more slowly than do the functional groups of the monomers that are used to build up the polymer main chain. The (potentially) hydrophilic groups can be nonionic or, preferably, ionic—that is, cationic or anionic—, hydrophilic groups or can be potentially ionic hydrophilic groups, and with particular preference can be anionic hydrophilic groups or potentially anionic hydrophilic groups.

The proportion of the components having (potentially) hydrophilic groups as a fraction of the total amount of components (a), (b), (c) and (d) is generally made such that the molar amount of the (potentially) hydrophilic groups, based on the amount by weight of all monomers (a) to (b), is 30 to 1000, preferably 50 to 500, and more preferably 80 to 300 mmol/kg.

Examples of suitable nonionic hydrophilic groups include mixed or pure polyethylene glycol ethers, made up of preferably 5 to 100, more preferably 10 to 80, repeating ethylene oxide units. Polyethylene glycol ethers may also contain propylene oxide units. If that is the case, then the amount of propylene oxide units is not to exceed 50 wt %, preferably 30 wt %, based on the mixed polyethylene glycol ether.

The amount of polyethylene oxide units is generally 0 to 10, preferably 0 to 6, wt %, based on the amount by weight of all monomers (a) to (d).

Preferred monomers containing nonionic hydrophilic groups are the polyethylene glycol and diisocyanates which carry a terminally etherified polyethylene glycol radical. Diisocyanates of this kind and also processes for their preparation are specified in U.S. Pat. No. 3,905,929 and U.S. Pat. No. 3,920,598.

Ionic hydrophilic groups are, in particular, anionic groups such as the sulfonate, the carboxylate and the phosphate group in the form of their alkali metal or ammonium salts and also cationic groups such as ammonium groups, especially protonated tertiary amino groups or quaternary ammonium groups.

Suitable monomers containing potentially anionic groups are usually aliphatic, cycloaliphatic, araliphatic or aromatic monohydroxycarboxylic and dihydroxycarboxylic acids which carry at least one alcoholic hydroxyl group or one primary or secondary amino group.

Such compounds are represented for example by the general formula

RG-R⁴-DG

in which

RG is at least one isocyanate-reactive group,

DG is at least one actively dispersing group and

R⁴ is an aliphatic, cycloaliphatic or aromatic radical comprising 1 to 20 carbon atoms.

Examples of RG are —OH, —SH, —NH₂ or —NHR⁵, where R⁵ can be methyl, ethyl, isopropyl, n-propyl, n-butyl, isobutyl, sec-butyl, tert-butyl, cyclopentyl or cyclohexyl.

Components of this kind are preferably, for example, mercaptoacetic acid, mercaptopropionic acid, thiolactic acid, mercaptosuccinic acid, glycine, iminodiacetic acid, sarcosine, alanine, 3-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, N-cyclohexylaminopropane-sulfonic acid, N-cyclohexylaminoethanesulfonic acid, and also the alkali metal, alkaline earth metal or ammonium salts thereof and, with particular preference, the stated monohydroxy-carboxylic and monohydroxysulfonic acids and also monoaminocarboxylic and monoaminosulfonic acids.

Very particular preference is given to dihydroxyalkylcarboxylic acids, especially those having 3 to 10 carbon atoms, as also described in U.S. Pat. No. 3,412,054. In particular are compounds of the general formula

HO—R¹—CR³(COOH)—R²—OH

in which R¹ and R² are each a C₁- to C₄-alkanediyl unit and R³ is a C₁- to C₄-alkyl unit. Of especial preference are dimethylolbutyric acid and particularly dimethylolpropionic acid (DMPA).

Also suitable are corresponding dihydroxysulfonic acids and dihydroxyphosphonic acids such as 2,3-dihydroxypropanephosphonic acid and also the corresponding acids in which at least one hydroxyl group has been replaced by an amino group, examples being those of the formula

H₂N—R¹—CR³(COOH)—R²—NH₂

in which R¹, R² and R³ can have the same meanings as specified above.

Otherwise suitable are dihydroxy compounds having a molecular weight above 500 to 10 000 g/mol and at least 2 carboxylate groups, which are known from DE-A 4 140 486. They are obtainable by reacting dihydroxyl compounds with tetracarboxylic dianhydrides such as pyromellitic dianhydride or cyclopentanetetracarboxylic dianhydride in a molar ratio of 2:1 to 1.05:1 in a polyaddition reaction. Particularly suitable dihydroxy compounds are the monomers (b2) listed as chain extenders, and also the diols (b1).

Potentially ionic hydrophilic groups are, in particular, those which can be converted by simple neutralization, hydrolysis or quaternization reactions into the abovementioned ionic hydrophilic groups, examples thus being acid groups, anhydride groups or tertiary amino groups.

Ionic monomers (d) or potentially ionic monomers (d) are described in detail in, for example, Ullmanns Encyklopadie der technischen Chemie, 4th edition, Volume 19, pp. 311-313 and, for example, in DE-A 1 495 745.

Monomers having tertiary amino groups, in particular, are of special practical significance as potentially cationic monomers (d), examples being the following: tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines and N-aminoalkyldialkylamines, the alkyl radicals and alkanediyl units of these tertiary amines consisting independently of one another of 2 to 6 carbon atoms. Also suitable are polyethers containing tertiary nitrogen atoms and preferably two terminal hydroxyl groups, such as are obtainable in a conventional manner by, for example, alkoxylating amines having two hydrogen atoms attached to amine nitrogen, examples being methylamine, aniline, or N,N′-dimethylhydrazine. Polyethers of this kind generally have a molar weight of between 500 and 6000 g/mol.

These tertiary amines are converted either with acids, preferably strong mineral acids such as phosphoric acid, sulfuric acid or hydrohalic acids, or strong organic acids, such as formic, acetic or lactic acid, or by reaction with appropriate quaternizing agents such as C₁ to C₆ alkyl halides, bromides or chlorides for example, or di-C₁ to C₆ alkyl sulfates or di-C₁ to C₆ alkyl carbonates, into the ammonium salts.

Suitable monomers (d) having isocyanate-reactive amino groups include aminocarboxylic acids such as lysine, β-alanine, the adducts, specified in DE-A2034479, of aliphatic diprimary diamines with α,β-unsaturated carboxylic acids such as N-(2-aminoethyl)-2-aminoethanecarboxylic acid, and also the corresponding N-aminoalkylaminoalkylcarboxylic acids, the alkanediyl units being composed of 2 to 6 carbon atoms.

Where monomers containing potentially ionic groups are used they can be converted into the ionic form before or during, but preferably after, the isocyanate polyaddition, since the ionic monomers are often only of very sparing solubility in the reaction mixture. With particular preference the anionic hydrophilic groups are in the form of their salts with an alkali metal ion or an ammonium ion as counterion.

Among these stated compounds, hydroxycarboxylic acids are preferred, very preferably dihydroxyalkylcarboxylic acids, and especially preferably α,α-bis(hydroxymethyl)carboxylic acids, more particularly dimethylolbutyric acid and dimethylolpropionic acid, and especially dimethylolpropionic acid.

In an alternative embodiment, the polyurethanes may contain not only nonionic hydrophilic groups but also ionic hydrophilic groups, preferably nonionic hydrophilic and anionic hydrophilic groups simultaneously.

Within the field of polyurethane chemistry it is general knowledge how the molecular weight of the polyurethanes can be adjusted by choosing the fractions of the co-reactive monomers and the arithmetic mean of the number of reactive functional groups per molecule.

Normally components (a), (b), (c), and (d) and their respective molar amounts are chosen such that the ratio A : B, where
A) is the molar amount of isocyanate groups, and
B) is the sum of the molar amount of the hydroxyl groups and the molar amount of the functional groups which are able to react with isocyanates in an addition reaction,

is 0.5:1 to 2:1, preferably 0.8:1 to 1.5 and more preferably 0.9:1 to 1.2:1. With very particular preference the ratio A:B is as close as possible to 1:1.

In addition to components (a), (b), (c), and (d) use is made of monomers containing only one reactive group generally in amounts of up to 15 mol %, preferably up to 8 mol %, based on the total amount of components (a), (b), (c), and (d).

The polyaddition of components (a) to (d) takes place in general at reaction temperatures of 20 to 180° C., preferably 50 to 150° C., under atmospheric pressure.

The reaction times required may extend from a few minutes to several hours. It is known within the field of polyurethane chemistry how the reaction time is influenced by a multiplicity of parameters such as temperature, monomer concentration, and monomer reactivity.

For accelerating the reaction of the diisocyanates it is possible to use the conventional catalysts. Those suitable in principle are all catalysts commonly used in polyurethane chemistry.

These are, for example, organic amines, particularly tertiary aliphatic, cycloaliphatic or aromatic amines, and/or Lewis-acidic organometallic compounds. Examples of suitable Lewis-acidic organometallic compounds include tin compounds, such as tin(II) salts of organic carboxylic acids, such as tin(II) acetate, tin(II) octoate, tin(II) ethylhexoate and tin(II) laurate, and the dialkyltin(IV) salts of organic carboxylic acids, such as dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate. Metal complexes such as acetylacetonates of iron, titanium, aluminum, zirconium, manganese, nickel, and cobalt are also possible. Further metal catalysts are described by Blank et al. in Progress in Organic Coatings, 1999, vol. 35, pages 19-29.

Preferred Lewis-acidic organometallic compounds are dimethyltin diacetate, dibutyltin dibutyrate, dibutyltin bis(2-ethylhexanoate), dibutyltin dilaurate, dioctyltin dilaurate, zirconium acetylacetonate, and zirconium 2,2,6,6-tetramethyl-3,5-heptanedionate.

Bismuth and cobalt catalysts as well, and also cesium salts, can be used as catalysts. Suitable cesium salts include those compounds in which the following anions are used: F⁻, Cl⁻, ClO⁻, ClO₃⁻, ClO₄⁻, Br⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄−, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, n standing for the numbers 1 to 20.

Preference is given to cesium carboxylates where the anion conforms to the formulae (CₙH₂ₙ₋₁O₂)⁻ and (Cₙ₊₁H₂ₙ₋₂O₄)²⁻ with n being 1 to 20. Particularly preferred cesium salts contain monocarboxylate anions of the general formula (CₙH₂ₙ₋₁O₂)⁻, where n stands for the numbers 1 to 20. Mention may be made in particular here of formate, acetate, propionate, hexanoate, and 2-ethylhexanoate.

Suitable polymerization apparatus include stirred tanks, especially when low viscosity and effective removal of heat are ensured by accompanying use of solvents.

Where the reaction is carried out in bulk, the usually high viscosities and the usually short reaction times dictate the use in particular of extruders, especially self-cleaning multi-screw extruders.

In the “prepolymer mixing process”, first of all, a prepolymer is prepared which carries isocyanate groups. Components (a) to (d) are in this case selected such that the as-defined ratio A:B is greater than 1.0 to 3, preferably 1.05 to 1.5. The prepolymer is first dispersed in water, an operation accompanied and/or followed by crosslinking, by reacting the isocyanate groups with amines which carry more than two isocyanate-reactive amino groups, or by chain extension, by reacting the isocyanate groups with amines which carry 2 isocyanate-reactive amino groups. Chain extension also takes place if no amine is added. In that case, isocyanate groups are hydrolyzed to amine groups, which are consumed by reaction with remaining isocyanate groups in the prepolymers, with chain extension.

The average particle size (z-average), measured by means of dynamic light scattering with the Malvern® Autosizer 2 C, of the dispersions prepared in accordance with the invention is not essential to the invention and is generally<1000 nm, preferably<500 nm, more preferably<200 nm, and very preferably between 20 and below 200 nm.

The dispersions generally have a solids content of 10 to 75, preferably of 20 to 65 wt % and a viscosity of 10 to 500 mPas (measured at a temperature of 20° C. and a shear rate of 250 s⁻¹.

For certain applications it may be useful to adjust the dispersions to a different, preferably a lower, solids content, by means of dilution, for example.

Furthermore, the dispersions prepared in accordance with the invention may be mixed with other components typical for the recited applications, examples being surfactants, detergents, dyes, pigments, color transfer inhibitors, and optical brighteners.

Following their preparation, if desired, the dispersions may be subjected to physical deodorization.

Physical deodorization may involve stripping of the dispersion using steam, an oxygen-containing gas, preferably air, nitrogen, or supercritical carbon dioxide, in, for example, a stirred vessel, as described in DE-B 12 48 943, or in a countercurrent column, as described in DE-A 196 21 027.

The amount of the N-acylmorpholine (I) of the invention when preparing the polyurethane is generally selected such that the fraction in the completed aqueous polyurethane dispersion, in other words after step II and optionally step III, does not exceed 30 wt %, is preferably not more than 25, more preferably not more than 20, and very preferably not more than 15 wt %.

The fraction of N-acylmorpholine (I) in the completed aqueous polymer dispersion, more particularly polyurethane dispersion, is generally at least 0.01 wt %, preferably at least 0.1, more preferably at least 0.2, very preferably at least 0.5, and more particularly at least 1 wt %.

The aqueous polymer dispersions, more particularly polyurethane dispersions, of the invention are suitable advantageously for the coating and adhesive bonding of substrates. Suitable substrates are wood, wood veneer, paper, paperboard, cardboard, textile, leather, synthetic leather, nonwoven, plastics surfaces, glass, ceramic, mineral construction materials, clothing, interior vehicle equipment, vehicles, metals or coated metals. They find application, for example, in the production of films or foils, for the impregnation of textiles or leather, as dispersants, as pigment dispersants, as primers, as adhesion promoters, as hydrophobizing agents, as laundry detergent additives, or as additives to cosmetic preparations, or for producing moldings or hydrogels.

In the context of their use as coating materials, the polymer dispersions, more particularly polyurethane dispersions, may be employed more particularly as primers, primer-surfacers, pigmented topcoat materials, and clearcoat materials in the sectors of automotive refinishing or large-vehicle finishing. The coating materials are particularly suitable for applications where requirement is for a particularly high reliability of application, outdoor weathering stability, optical qualities, resistance to solvents, chemicals, and water, such as in automotive refinishing and large-vehicle finishing.

Aqueous polymer dispersions, more particularly polyurethane dispersions, of the invention, and polyurethane dispersions prepared by the process of the invention, have at least one of the following advantages over polymer dispersions or polyurethane dispersions as known from the prior art:
Reduced solvent demand.
The dispersions are easier to spray or squirt, depositing less/fewer crusts or impurities on spraying tools.
Low toxicity.
The prepolymer solutions have a lower viscosity.
The rheological behavior of the polyurethane dispersions is improved.
The wetting behavior of substrates or additives is improved.
Lower yellowing under light and/or effect of heat.
Higher frost resistance on the part of the dispersions.
Improved flexibility, especially low-temperature flexibility of the films obtained.
Higher gloss of the films obtained.
Improved flow leveling of the film.
Improved film-forming properties.
Improved adhesion to the substrate material of the coating produced from the polymer dispersion.

The addition of N-acylmorpholines to polymer dispersions, either before, during or after the preparation and/or dispersing of the polymer or polyurethane, enhances the adhesion of the coating produced from such a polymer dispersion to the substrate material. This is especially so in respect of substrate materials which have a polymer surface, more particularly a surface of polyurethane.

Polymer dispersions of the invention have a low viscosity, in particular.

Further provided by the invention is the use of N-acylmorpholines of formula (I) as solvents in the preparation of polymers, more particularly polyurethanes, more particularly of aqueous polyurethane dispersions, preferably by the prepolymer mixing process.

Further provided by the invention are aqueous polyurethane dispersions prepared by the process of the invention.

Further provided by the present invention are coating compositions comprising at least one polymer dispersion, more particularly polyurethane dispersion, of the invention, and also articles coated therewith.

Additionally provided by the invention is the use of polymer dispersions of the invention, especially polyurethane dispersions, for the coating or impregnation of surfaces such as leather, wood, textile, synthetic leather, metal, plastics, clothing, furniture, interior automotive equipment, vehicles, paper, organic polymers, more particularly polyurethane.

Further provided by the invention are coating compositions comprising aqueous polymer dispersions prepared from polymer dispersions of the invention, and also articles coated therewith.

Unless otherwise indicated, ppm and percent figures used in this specification relate to weight percentages and weight-ppm.

### EXAMPLES

I. Preparation of Polyurethane Dispersions

Abbreviations

DETA Diethylenetriamine

DMEA Dimethylethanolamine

DMPA Dimethylolpropionic acid

EDA Ethylenediamine

IPDA Isophoronediamine

IPDI Isophorone diisocyanate

NEP N-Ethylpyrrolidone

NMP N-Methylpyrrolidone

PUD Polyurethane dispersion

TDI Tolylene diisocyanate (80% 2,4- and 20% 2,6-isomer)

TEA Triethylamine

### Example 1

### Formylmorpholine as Solvent

A stirring flask with reflux condenser and thermometer was charged with 400 g (0.20 mol) of a polypropylene oxide with an OH number of 56, 32.2 g (0.24 mol) of DMPA, and 50 g of N-formylmorpholine, and this initial charge was stirred at 65° C. 76.6 g (0.44 mol) of TDI were added and the mixture was stirred at 110° C. for 360 minutes. It was then diluted with 400 g of acetone and the NCO content was found to be 0.01 wt % (calculated: 0.00%). After this, 10.0 g (0.10 mol) of TEA were added. Following dispersion with 800 g of water, the acetone was removed by distillation under reduced pressure.

This gave a finely divided PUD with a 44.8% solids content and a viscosity of 23 mPas at 23° C. and a shear rate of 250/s.

### Example 2

### Acetylmorpholine as Solvent

A stirring flask with reflux condenser and thermometer was charged with 400 g (0.20 mol) of a polypropylene oxide with an OH number of 56, 32.2 g (0.24 mol) of DMPA, and 50 g of acetylmorpholine, and this initial charge was stirred at 65° C. 76.6 g (0.44 mol) of TDI were added and the mixture was stirred at 110° C. for 360 minutes. It was then diluted with 400 g of acetone and the NCO content was found to be 0.03 wt % (calculated: 0.00%). After this, 10.0 g (0.10 mol) of TEA were added. Following dispersion with 800 g of water, the acetone was removed by distillation under reduced pressure.

This gave a finely divided PUD with a 38.4% solids content and a viscosity of 17 mPas at 23° C. and a shear rate of 250/s.

### Comparative Example 3

Example 1 was repeated, but with 50 g of NMP instead of the N-formylmorpholine. The NCO content was found to be 0.01 wt % (calculated: 0.00%).

This gave a finely divided PUD with a 44.1% solids content and a viscosity of 99 mPas at 23° C. and a shear rate of 250/s.

### Comparative Example 4

Example 1 was repeated, but with 50 g of NEP instead of the N-formylmorpholine. The NCO content was found to be 0.02 wt % (calculated: 0.00%).

This gave a finely divided PUD with a 40.1% solids content and a viscosity of 285 mPas at 23° C. and a shear rate of 250/s.

TABLE 1
Properties of polymer dispersions in examples 1 to 4.

| | | Solid content | Viscosity |
|---|---|---|---|
| Example | Solvent | (%) | (mPas) |
| 1 | Formylmorpholine | 44.8 | 23 |
| 2 | Acetylmorpholine | 38.4 | 17 |
| 3 | NMP | 44.1 | 99 |
| 4 | NEP | 40.1 | 285 |

### Comparative Example 5

### NMP

A stirring flask with reflux condenser and thermometer was charged with 400 g (0.20 mol) of a polyester diol with an OH number of 56 prepared from neopentyl glycol, hexane-1,6-diol and adipic acid, and with 26.09 g (0.19 mol) of DMPA and 150 g of NMP, and this initial charge was stirred at 80° C. for 30 minutes. 175.5 g (0.79 mol) of IPDI were added and the mixture was stirred at 95° C. After four hours, an NCO content of 4.44% was reached (calculated: 4.41%). Following the addition of 19.71 g (0.19 mol) of TEA, the prepolymer was dispersed in 672 g of water. The dispersion was admixed with a mixture of 66 g of water and 22.53 g of EDA.

### Example 6

### Formylmorpholine

The procedure of comparative example 8 was repeated, but replacing the NMP by the same mass of formylmorpholine.

### Example 7

### Acetylmorpholine

The procedure of comparative example 8 was repeated, but replacing the NMP by the same mass of acetylmorpholine.

The dispersions from examples 5, 6 and 7 were poured out into a glass tray and dried at room temperature for 7 days to produce films. The amount of dispersion was chosen so as to give dry films having a thickness of about 1 mm.

Table 2 summarizes the properties of the dispersions and of the films obtained from them.

The viscosities were determined with a Paar Physica rotational viscometer in accordance with DIN 53019.

For determining the LT (light transmittance), each of the polymer dispersions under investigation, in aqueous dilution in a cuvette with a cuvette with an edge length of 2.5 cm, is subjected to measurement with light with a wavelength of 600 nm, and compared with the corresponding transmittance of water under the same measurement conditions. The transmittance of water is stated here as 100%. The more finely divided the dispersion, the higher the LT as measured by the method described above. The LT values were determined for the dispersion in question as a 0.1% strength aqueous solution, using a Hach DR/2010 instrument, at a wavelength of 600 nm.

The average particle sizes were determined by dynamic light scattering in a Malvern Zetasizer APS.

The film hardnesses (Shore hardnesses) were determined according to DIN EN ISO 868.

Tensile Strength and elongation at break were determined according to ISO 37.

TABLE 2
Properties of the dispersions from examples
5 to 7 and of the films obtained from them.

| | Comparative | Example 6 | Example 7 |
|---|---|---|---|
| | example 5 | Formylmor- | Acetylmor- |
| | NMP | pholine | pholine |
| Solids content (%) | 40.4 | 40.3 | 40.4 |
| pH | 8.95 | 8.64 | 8.47 |
| Viscosity (mPas) | 102 | 40 | 64 |
| LT (%) | 98.5 | 98.6 | 98.1 |
| Average particle size (nm) | 74 | 71 | 70 |
| Film properties | | | |
| ° Shore hardness A | 90 | 88 | 89 |
| ° Shore hardness D | 41 | 40 | 41 |
| Tensile strength (N/mm2) | 61 | 55 | 66 |
| Elongation at break | 711 | 708 | 710 |

It is clearly seen that the use of acylmorpholines produces dispersions having reduced viscosity and films having identical properties.

II. Seasoning of Leather

Products used:

Lepton® Farben N

Lepton Farben N products are colored, casein-free leather finishers.

Lepton® Filler FCG

Lepton® Filler FCG is a leather finishing filler based on aqueous wax dispersions, matting agent and additives.

Astacin® Finish SUSI TF

Astacin® Finish SUSI TF is a very soft bottoming binder based on an aliphatic polyesterurethane dispersion.

Astacin® Finish PS

Astacin® Finish PS is a soft bottoming binder based on an aliphatic polyetherurethane dispersion.

Astacin® Finish PTM

Astacin® Finish PTM is a hard and matt bottoming binder based on an aliphatic polyetherurethane dispersion and matting agent.

Corial® Binder DN

Corial® Binder DN is a soft bottoming binder with very good low-temperature flexibility, based on an acrylate polymer dispersion.

Astacin® Novomatt GG

Astacin® Novomatt GG is a moderately hard, matt and flexible topcoat binder based on an aliphatic polyesterurethane dispersion and matting agent.

Astacin® Matting HS

Astacin® Matting HS is a hard, matt and flexible topcoat binder based on a polycarbonate dispersion and matting agent.

Astacin® Novomatt GG

Astacin® Novomatt GG is a moderately hard, very matt and flexible topcoat binder based on an aliphatic polyesterurethane dispersion, matting agent and additives.

Lepton® Protector SR

Lepton® Protector SR is an antisoiling auxiliary based on a modified acrylate polymer dispersion and additives.

Lepton® Matting AL

Lepton® Matting AL is a silicate-free, polymeric matting agent.

Lepton® Wax WN

Lepton® Wax WN is a silicone emulsion based on high molecular mass polysiloxanes.

Lepton® Wax DS

Lepton® Wax DS is a silicone emulsion with minimal film-forming, based on high molecular mass polysiloxanes.

Amollan® SW

Amollan® SW is a leveling assistant based on a low-viscosity silicone polyether liquid.

Astacin® Hardener CA

Astacin® Hardener CA is a crosslinker for leather finishing, based on polycarbonate and emulsifiers.

Astacin® Hardener CN

Astacin® Hardener CN is a crosslinker for leather finishing, based on an aliphatic polyisocyanate and organic solvent.

### Comparative Example

1. First Bottoming:

A leather suitable for applications in the automotive interior sector was bottomed, using a roll coater, with a liquor containing

150 parts Lepton® Farben N

100 p. Lepton® Filler FCG

100 p. Astacin® Finish SUSI TF

150 p. Astacin® Finish PS

100 p. Astacin® Finish PTM

100 p. Corial® Binder DN

65 p. Astacin® Novomatt GG

5 p. Amollan® SW

40 p. Astacin® Hardener CA.

The liquor is adjusted by addition of 30 parts of water to a flow viscosity of 40 sec in the 4 mm cup according to DIN EN ISO 2431:2011.

The wet application weight was 8.0±0.5 g/ft². The leathers were dried at 80° C. for 1.5 minutes in a forced-air drying tunnel.

2. Second Bottoming:

The leather singly bottomed accordingly was bottomed a second time by spray application of a liquor containing

150 parts Lepton® Farben N

100 p. Lepton® Filler FCG

100 p. Astacin® Finish SUSI TF

150 p. Astacin® Finish PS

100 p. Astacin® Finish PTM

100 p. Corial® Binder DN

65 p. Astacin® Novomatt GG

5 p. Amollan® SW

40 p. Astacin® Hardener CA.

The liquor is adjusted by addition of 130 parts of water to a flow viscosity of 24 sec in the 4 mm cup according to DIN EN ISO 2431:2011.

The wet application weight was 2.4±0.2 g/ft². The leathers were dried at 80° C. for 1.5 minutes in a forced-air drying tunnel.

The bottomed leather was stored overnight, embossed at a temperature of 140° C./a pressure of 210 bar/in a residence time of 3 seconds, stored for 3 hours, and milled for 3 hours.

3. First Seasoning:

The doubly bottomed leather was seasoned the first time by means of spray application of a liquor containing

150 parts Lepton® Farben N

60 p. Lepton® Filler FCG

100 p. Astacin® Finish SUSI TF

150 p. Astacin® Finish PS

75 p. Astacin® Finish PTM

200 p. Astacin® Matting HS

65 p. Astacin® Novomatt GG

3 p. Amollan® SW

60 p. Astacin® Hardener CN.

The liquor is adjusted by addition of 220 parts of water to a flow viscosity of 20 sec in the 4 mm cup according to DIN EN ISO 2431:2011.

The wet application weight was 2.0±0.2 g/ft².

The leathers were dried at 80° C. for 1.5 minutes in a forced-air drying tunnel.

4. Second Seasoning:

The singly seasoned leather was seasoned the second time by means of spray application of a liquor containing

20 parts Lepton® Farben N

350 p. Astacin® Matting HS

150 p. Astacin® Novomatt GG

75 p. Lepton® Protector SR

40 p. Lepton® Matting AL

40 p. Lepton® Wax WN

40 p. Lepton® Wax DS

3 p. Amollan® SW

120 p. Astacin® Hardener CN.

The liquor is adjusted by addition of 330 parts of water to a flow viscosity of 28 sec in the 4 mm cup according to DIN EN ISO 2431:2011.

The wet application weight was 2.0±0.2 g/ft².

The leathers were dried at 80° C. for 1.5 minutes in a forced-air drying tunnel.

The bottomed and seasoned leather was stored overnight.

### Inventive Example

Steps 1. and 2. of the comparative example were repeated.

In steps 3. and 4., 50 p. N-formylmorpholine in each case were added to the liquor.

Testing

After each coating step, the wet adhesion of the finish was tested in accordance with DIN EN ISO 11644.

| | Wet adhesion of the finish according | | | |
|---|---|---|---|---|
| | to DIN EN ISO 11644/N/cm) | | | |
| | 1st | 2nd | 1st | 2nd |
| | bottoming | bottoming | seasoning | seasoning |
| Comparative | 5.7 | 4.0 | 2.0 | 3.5 |
| example | | | | |
| Inventive | 5.2 | 4.7 | 3.0 | 8.9 |
| example | | | | |

1. An aqueous polymer dispersion, comprising at least one N-acylmorpholine of formula (I) 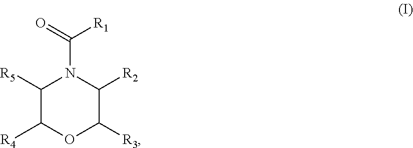
where R₁ is H or an alkyl radical having 1 to 18C atoms, and R₂, R₃, R₄, and R₅ each independently of one another are a hydrogen atom or a (cyclo)alkyl radical having 1 to 18C atoms.

2. The polymer dispersion according to claim 1, comprising 0.01 wt % to 30 wt % of the at least one N-acylmorpholine of formula (I).

3. The polymer dispersion according to claim 1, wherein R₁ is selected from the group consisting of H, methyl, and ethyl.

4. The polymer dispersion according to claim 1, wherein R₂, R₃, R₄, and R₅ are each independently selected from the group consisting of hydrogen, methyl, ethyl, isopropyl, and cyclohexyl.

5. The polymer dispersion according to claim 1, wherein the N-acylmorpholine is at least one morpholine selected from the group consisting of N-formylmorpholine, N-acetylmorpholine, and N-propionylmorpholine.

6. The polymer dispersion according to claim 1, which is a polyurethane dispersion.

7. A process for preparing the polymer dispersion according to claim 6, the process comprising:
(A) preparing a polyurethane in the presence of the N-acylmorpholine of formula (I); and
(B) subsequently dispersing the polyurethane in water.

8. The process according to claim 7, wherein
the preparing (A) is carried out by reacting
a) at least one polyfunctional isocyanate having 4 to 30C atoms,
b) diols which comprises
b1) 10 to 100 mol %, based on a total amount of the diols (b), of a diol having a molecular weight of 500 to 5000, and
b2) 0 to 90 mol %, based on the total amount of the diols (b), of a diol having a molecular weight of 60 to 500 g/mol,
c) optionally at least one polyfunctional compound, which is different from the diols (b) and has reactive groups selected from the group consisting of an alcoholic hydroxyl group, a primary amino group, and a secondary amino group, and
d) at least one monomer different from (a), (b), and (c) and comprising
at least one isocyanate group or at least one group reactive toward an isocyanate group, and
at least one hydrophilic group or potentially hydrophilic group,
to give the polyurethane, and
the process optionally further comprises adding polyamines after or during the dispersing (B).

9. The process according to claim 7, wherein R₁ is selected from the group consisting of H, methyl, ethyl.

10. The process according to claim 7, wherein R₂, R₃, R₄, and R₅ are each independently selected from the group consisting of hydrogen, methyl, ethyl, isopropyl, and cyclohexyl.

11. The process according to claim 7, wherein the N-acylmorpholine is at least one morpholine selected from the group consisting of N-formylmorpholine, N-acetylmorpholine, and N-propionylmorpholine.

12. A method for coating and adhesive bonding wood, wood veneer, paper, paperboard, cardboard, textile, leather, synthetic leather, nonwoven, plastics surfaces, glass, ceramic, mineral construction materials, metals, or coated metals, the method comprising
applying the polymer dispersion according to claim 1 to the wood, wood veneer, paper, paperboard, cardboard, textile, leather, synthetic leather, nonwoven, plastics surfaces, glass, ceramic, mineral construction materials, metals, or coated metals.

13. A method for preparing a polyurethane, the method comprising:
preparing the polyurethane from a substituted N-acylmorpholines of formula (I) 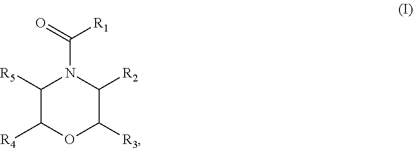
where R¹ is H or an alkyl radical having 1 to 18C atoms, and R₂, R₃, R₄, and R₅ each independently of one another are a hydrogen atom or a (cyclo)alkyl radical having 1 to 18C atoms.

14. A method for coating a surface, the method comprising
applying the polymer dispersion according to claim 1 to the surface.

15. A coating composition, comprising the polymer dispersion according to claim 1.

16. A method for coating and adhesive bonding wood, wood veneer, paper, paperboard, cardboard, textile, leather, synthetic leather, nonwoven, plastics surfaces, glass, ceramic, mineral construction materials, metals, or coated metals, the method comprising
applying a polyurethane dispersion obtained by the process according to claim 7 to the wood, wood veneer, paper, paperboard, cardboard, textile, leather, synthetic leather, nonwoven, plastics surfaces, glass, ceramic, mineral construction materials, metals, or coated metals.
